(19) United States
(12) Patent Application Publication
(10) Pub. No.: US 2023/0393911 A1
(43) Pub. Date: Dec. 7, 2023

(54) Schema Determination and Modification For Event Driven Messaging

(71) Applicant: Batch.sh Inc., Chattanooga, TN (US)

(72) Inventors: Ustin Zarubin, Chattanooga, TN (US); Daniel Selans, Portland, OR (US)

(21) Appl. No.: 17/977,831

(22) Filed: Oct. 31, 2022

Related U.S. Application Data
(60) Provisional application No. 63/348,239, filed on Jun. 2, 2022.

(51) Int. Cl. G06F 9/54; G06F 16/28; G06F 16/21

(52) U.S. Cl. CPC G06F 9/542; G06F 9/546; G06F 16/285; G06F 16/212

(57) ABSTRACT

Message schema determination and modification described herein allow users to gain insight into their distributed systems. In some implementations, the platform is able to collect messages from the client's systems, store the events in a proper structure, provide functionality to search the collected events and replay collected events back through the client's systems. The processing and storing of the events by the platform can be performed in near-real time, which can allow the client to obtain timely insight into their events. Related apparatus, systems, techniques, and articles are also described.

### CROSS-REFERENCE TO RELATED APPLICATION

This application claims priority under 35 U.S.C. § 119 to U.S. Provisional Application No. 63/348,239 filed Jun. 2, 2022, the entire contents of which is hereby incorporated by reference herein.

### BACKGROUND

Event-driven messaging is a design pattern, applied within the service-orientation design paradigm, to enable the service consumers, which are interested in events that occur within the periphery of a service provider, to get notifications about these events as and when they occur without resorting to the traditional inefficient polling based mechanism.

Apache Kafka is a distributed event store and stream-processing platform. It is an open-source system developed by the Apache Software Foundation written in Java and Scala. The project aims to provide a unified, high-throughput, low-latency platform for handling real-time data feeds. Kafka can connect to external systems (for data import/export) via Kafka Connect and provides the Kafka Streams libraries for stream processing applications. Kafka uses a binary TCP-based protocol that is optimized for efficiency and relies on a “message set” abstraction that naturally groups messages together to reduce the overhead of the network roundtrip.

### SUMMARY

In an aspect, a method comprising: receiving, by a first computing environment, a first message from a second computing environment remote from the first computing environment, the first message including a first field and a first data associated with the first field; determining, based on the first field, a schema of the first message, the schema including a first category associated with the first field; transforming a format of the first message into a second format; receiving, by the first computing environment, a second message from the second computing environment, the second message including a second field and a second data associated with the second field; and modifying the schema to further include a second category of the second field, the modified schema including the first category and the second category.

In another aspect, a system comprising at least one data processor storing instructions which, when executed, cause the at least one data processor to perform operations comprising: receiving, by a first computing environment, a first message from a second computing environment remote from the first computing environment, the first message including a first field and a first data associated with the first field; determining, based on the first field, a schema of the first message, the schema including a first category associated with the first field; transforming a format of the first message into a second format; receiving, by the first computing environment, a second message from the second computing environment, the second message including a second field and a second data associated with the second field; and modifying the schema to further include a second category of the second field, the modified schema including the first category and the second category.

In yet another aspect, at least one non-transitory storage media storing instructions that, when executed by at least one processor, cause the at least one processor to perform operations comprising: receiving, by a first computing environment, a first message from a second computing environment remote from the first computing environment, the first message including a first field and a first data associated with the first field; determining, based on the first field, a schema of the first message, the schema including a first category associated with the first field; transforming a format of the first message into a second format; receiving, by the first computing environment, a second message from the second computing environment, the second message including a second field and a second data associated with the second field; and modifying the schema to further include a second category of the second field, the modified schema including the first category and the second category.

### DESCRIPTION OF DRAWINGS

FIG. 1 illustrates an example event insight platform according to some example implementations of the current subject matter;

FIG. 2 is an example method of ingesting, processing and storing events, such as by the event insight platform of FIG. 1;

FIG. 3 illustrates an example flow chart listing the steps for implementing the schema modification and determination of the present disclosure, according to one or more implementations described and illustrated herein; and

Like reference symbols in the various drawings indicate like elements.

### DETAILED DESCRIPTION

Some implementations of the current subject matter include an event insight platform that allows users to gain insight into their distributed systems by collecting, processing, and storing events or messages from the various messaging systems employed by a user. In some implementations, the platform is configured to collect messages from the client's systems, store the events in a proper structure, provide functionality to search the collected events and replay collected events back through the client's systems. The processing and storing of the events by the platform can be performed in near-real time, which can allow the client to obtain timely insight into their events.

In some implementations, the client is able to interact with the platform to configure the collection of the events from the client systems. The platform can provide a number of tools to assist with this client interaction. For example, the tools can include a relay. The relay can interact with a variety of messaging systems and can be further configured to decode event data. This relay functionality allows the platform to gain insight into events that it would otherwise be unable to process.

In some examples, for collected events that do not include schema information, or for which the client has not provided a schema, the platform can infer a schema from the collected events. A parser can be included that is configured to analyze the structure and content of an event. Analyzed information from the parser can be used to create an equivalent schema such as, for example, a parquet schema. This schema can then be used by the platform to store the collected events.

Some implementations include a schema election process that can be used when a schema of a collected event conflicts with the schema currently being used with the collected event. When this occurs, a schema election process can be initiated and the various platform services collect and analyze the schema of incoming events to provide an elected schema. The elected schema(s) can be used to develop an updated or revised schema that becomes a newly elected schema that each of the services then adopts for use. The schema inference and election processes provide for the platform to automatically determine a schema from the collected events and to update the schema as needed based on further collected events.

In some implementations, the platform includes search functionality that allows the client to search the contents of their collected events using one or more different criteria. Clients can use the search functionality to select all or a portion of the collected events. The user-selected events can then be replayed through the client's systems. Such implementation can assist the client with testing functionality of their systems and can also be used to process events that may not have been fully processed by the client's systems initially.

Currently, there are few ways that users can gain insight into their messaging systems. Application performance monitoring (APM) services provide some insight but they have many shortcomings since they are only monitoring the applications themselves. In many cases, the APMs lack the ability to actually examine the data that is being passed, to provide any sort of insight if the messages are encoded, and many others desired functionalities.

Additionally, many of the current systems require a high skill level to implement and use correctly. Oftentimes, this requires the use of developers to develop and implement specific coding to achieve the desired results. This can be costly and time consuming.

Further, many of the tools that provide insight into the messaging of distributed systems are platform specific. That is, the tools only work with a specific messaging platform. This reduces their universal applicability and overall appeal for users.

As such, there is a lack of a tool or system that provides insights into the message trafficked in distributed systems.

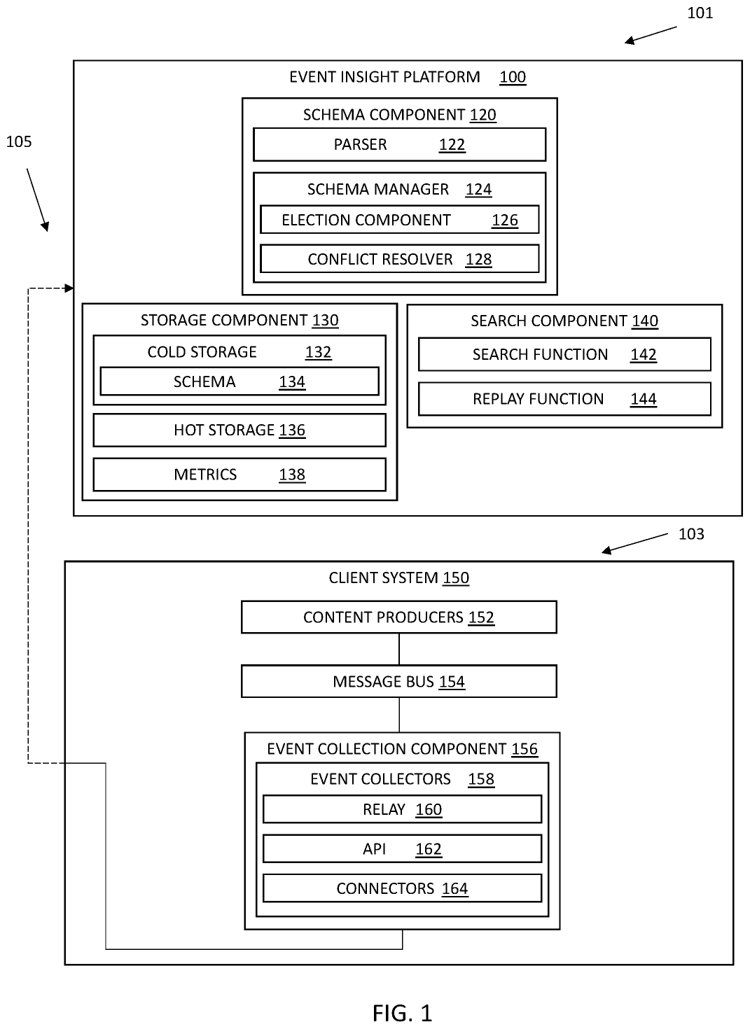

FIG. 1 illustrates an example implementation of the event insight platform 100. In some implementations, the event insight platform 100 may be within a first computing environment 101. In implementations, the first computing environment 101 may include at least a device in the form of a computing device operating in conjunction with one or more servers that are separate from and external to the computing device. In implementations, the event insight platform 100 may be accessible via and operable on the computing device and the one or more servers such that data may be shared between the servers and computing device, e.g., in near real-time. In implementations, one or more versions of the event insight platform 100 may operate concurrently on the computing device and on each of the one or more servers.

In implementations, FIG. 1 illustrates a second computing environment 103 that is remote from the first computing environment 101. In implementations, the second computing environment 103 is communicatively coupled with the first computing environment 101 via a communication network 105 that is indicated, for illustration purposes only, as a dotted line connecting a client system 150, operating in the second computing environment 103, with the event insight platform 100 in the first computing environment.

In some implementations, the first computing environment 101 can include a remote computing environment provided as an infrastructure as a service (“IaaS”). In implementations, cloud providers may be a part of and provide a remote computing environment, which may include virtual machine (VM) infrastructure such as a hypervisor using native execution to share and manage hardware, allowing for multiple environments which are isolated from one another yet exist and run concurrently on the same physical machine. The computing environment can include an IaaS platform configured to provide application programming interfaces (APIs) to dereference low-level details of underlying network infrastructure. In such an IaaS platform, pools of hypervisors can support large numbers of VMs and include the ability to scale up and down services to meet varying needs in real-time (or near real-time). IaaS platforms can provide the capability to the user of provision processing, storage, networks, and other fundamental computing resources where the user is able to deploy and run arbitrary software, which can include operating systems and applications. The user may not manage or control the underlying cloud infrastructure but has control over operating systems, storage, and deployed applications; and possibly limited control of select networking components (e.g., host firewalls). Some IaaS platforms can sometimes be referred to as a cloud, and operators of the IaaS platform can be referred to as a cloud provider.

In implementations, the client system 150 may be a combination of hardware and software components comprising a client's Information Technology (“IT”) infrastructure, e.g., one or more computers operating independently and/or in conjunction with each other and being communicatively coupled to one or more servers that are within the second computing environment 103 and/or one or more servers that are external to the second computing environment 103. In implementations, the client system 150 and the one or more servers included as part of the second computing environment 103 may operate a software application (e.g., an agent) that tracks content (e.g., text messages, video, audio, and various other forms of communications and digital content within the client's IT infrastructure), shares the tracked content within the IT infrastructure, and transmits the content to one or more external devices, e.g., event insight platform 100 in the first computing environment 101.

In implementations, the client system 150 may include various components such as the message content producers component 152, the message bus component 154, and an event collection component 156. Event collection component 156 can include various subcomponents, e.g., event collectors 158, a relay 160, APIs 162, and connectors 164. Details regarding the operation and functionality of each of the respective components of the client system 150 are described in greater detail later on in this disclosure.

In implementations, the message content producers component 152 may refer to various hardware and software components that generate messages such as, e.g., text messages, images, video, and so forth. All of the content that the message content producers component 152 generates may be routed to the event collection component 156 via a message bus component 154.

In implementations, the event collection component 156 collects events and/or messages that pass through one or more systems, such as those used by a client, e.g., systems that are associated with one or more devices that comprise the client's IT infrastructure and various software applications, platforms, and so forth, that are operable on these devices. The event collection component 156 can use various event collectors 158 to collect the events (e.g., text messages, images, video, and so forth) from the client system 150 and transmit these events to the event insight platform 100 for the purposes of performing various operations and analyses. The events collected by the event collection component 156 are organized into collections. In implementations, the collections can be specified by the user and are given a unique token that is used to identify the events associated with the identified collection of events within the event insight platform 100.

As stated above, the event collectors 158 can include the relay 160 (e.g., plumber relay), various APIs 162 and/or connectors 164. The client system 150 deploys the event collectors 158 in their systems to collect the events generated by that system. The collection of these events does not alter or impact the clients' systems. The events are collected and transmitted to the event insight platform 100, which enables users to use the tools and features of the event insight platform 100 to gain insight into these events, e.g., in near real-time. Previously, such insights would normally be gained after a period of time during which events were collected. With the event insight platform 100, users can see and search their events with greater efficiency and ease. As described herein, the event insight platform 100 provides numerous tools to streamline the searching, processing, and analysis of the collected events.

In implementations, the relay 160 integrates with a variety of different messaging systems. The relay 160 can further serve as a mechanism for better tracking and routing of messages within various devices of the client system 150 and to the event insight platform 100 in the first computing environment 101. With relay 160, the event insight platform 100 can provide the various features and capabilities to a number of messaging systems, allowing the event insight platform 100 to be agnostic to the messaging system or type of message. Additionally, the relay 160 can batch the collected events, which allows for an increased throughput of the events in the event insight platform 100. In implementations, a component that is comparable to the relay 160 may be included as part of the event insight platform 100 as well, which operates concurrently and in conjunction with the relay 160.

In implementations, the event collection component 156, which includes the event collectors 158 and the relay 160, can include or interact with a decoder that is able to decode event data. For example, one or more of the messages that are collected by the event collectors 158 may be encoded. The encoded nature of the event data can prevent interpretation of the contents of the event. Thereafter, in implementations, the encoded event data may be transmitted to the event insight platform 100 via the communication network 105. Upon or after receiving, the event insight platform 100 may decode the encoded event data.

By decoding the event, the event insight platform 100 may be enabled to gain insight into the content of the data, which can be used for processing, analyzing and storing the collected events. In an example, the decoding of the encoded events can occur in near real-time, to allow the near real-time functionality and features of the event insight platform 100 to be used with the collected events.

The APIs 162 and connectors 164 provide alternative pathways through which a user can route their system events/messages to the event insight platform 100. Example APIs 162 can include a traditional HTTP API and the gRPC API, which the user can configure to collect events/messages from their systems and provide the collected events to the event insight platform 100. The connectors 164 can be systems or source specific connectors that a user can deploy within their specific system or data source to relay events/messages from the connected system to the event insight platform 100.

In implementations, as stated above, the messages that are routed to the event collection component 156 are transmitted, in real time, to the event insight platform 100. The event insight platform 100 collects events or messages from various services, infers or generates a schema from received events, and stores the event (e.g., message) in the proper schema. Additionally, the event insight platform 100 provides tools to allow users to easily search the events and to replay them back into a system if needed. The capabilities of the event insight platform 100 allows insight from the events to be generated in real-time and simplifies the complex process of properly storing the incoming events and their associated data.

A description of the various components of the event insight platform 100 is provided below. In implementations, the event insight platform 100 includes a number of components, including a schema component 120, a storage component 130, and a search component 140. The various components of the event insight platform 100 interact, process and analyze the events received from a client system(s) to provide the various capabilities and features of the event insight platform 100.

As previously mentioned, the events collected by the event collection component 156 are organized into collections. Additionally, a message schema is applied to each collection, with the schema being generated or inferred by the event insight platform 100. If the schema is provided or defined already, either in the received events/messages or by the user as part of setting up the collection of the messages, the schema will not need to be inferred. In instances where the schema of the event is not provided, the schema component 120 of the event insight platform 100 may infer or generate a schema that is associated with a particular event. In implementations, it is noted that a first event that is received as part of a first data stream from the client system 150 may not have an associated schema. In implementations, the schema component 120 may analyze data of the first event and generate a schema that is associated with and specific to one or more fields of the schema component 120.

In various instances, the user can define and provide the event or message schema to a system that collects, handles and stores event data, e.g., as the event insight platform 100 does. However, this process takes time and the defined schemas may need to be routinely updated in response to changes in the event data structure. The automatic inference of a schema by the schema component 120 reduces this burden as the schema is automatically generated and can be updated or revised automatically based on the ongoing and iterative analysis of the received events and their structure. That is, the schema component 120 of the event insight platform 100 can monitor subsequent events and update the inferred schema based on the received events and their structure. This capability greatly reduces the burden on the user to define and maintain different schemas for each of the various event structures that might be transmitted.

The schema component 120 examines events of a collection to determine a suitable schema for the events, which allows the events to be stored and queried. In examples, the schema component 120 can use an election process to select the schema. In some implementations, changes in the structure of the subsequent events can trigger the schema component 120 to elect a new schema. In this manner, the schema component 120 can automatically update the elected schema based on the incoming events so that the currently elected schema remains relevant. The schema component 120 includes a parser 122 and a schema manager 124 that assist with determining and selecting a schema to be used for the incoming events associated with a particular collection. Typically, the schema component 120 is used to infer a schema of JSON events/messages, as other event or message formats are likely to include relevant schema information that can be used for processing and storing the events. The schema component 120 can use such a schema election process in all cases regardless of the underlying event encoding type.

In examples, the parser 122 is a combination lexical parser and abstract syntax tree (AST) parser that can convert the existing structure of the event into a parquet equivalent. Such a parser 122 allows the collected event to be stored in a parquet structure. The parser 122 processes an event by walking the tree of an event, such as a JSON message, to determine the data types in the event. To do so, the parser 122 constructs a syntax tree by parsing the event structure on a character-by-character level. From this, the parser 122 can convert the event data structure into a parquet schema by using a set of predefined parquet schema equivalencies. In this manner, the parser 122 can determine a parquet schema from the structure of a received event, such as a JSON message.

The schema manager 124 oversees and manages the schema for the collection, including election component 126 and conflict resolver 128. The election component 126 operates across distributed systems and is able to elect a schema that will be used to store the collected events. Additionally, the election of the schema may result in revision of the schema when there are changes that are detected in the schema of one or more of the collected events being received or processed across these systems. Through the election process, the schema can be revised so that the schema works for all of the events in the collection. However, there may be instances where the structure of an event cannot be reconciled with the existing schema. In such an example, the conflict resolver 128 may operate to resolve the conflict and to allow the continued processing of the collection.

The election component 126 elects or selects a schema from one or more proposed schemas associated with a collection that are being ingested. During the collection of the events or messages, one or more systems of the distributed systems may emit an event or message that does not conform to the schema of another. The two different schemas of the two different events creates a conflict, whereby the overall schema does not work for all of the events. When this is detected, the election component 126 may be initiated to update or revise the schema so that it becomes applicable to all of the events.

In an example, a collector may be collecting events and using an already inferred schema to process the events, such as a schema created by the parser 122. The collector may then receive a subsequent message that conflicts with the existing schema that is being used by the collector. When this occurs, the collector can emit a message onto the message bus that a schema election needs to occur to update the schema being used for a particular collection.

The emitted schema message will cause the incoming data for that collection to be temporarily paused from being written to storage. This allows the incoming event data to be collected and the schema for each event to be inspected. The amount of event data that is collected can be predefined as a period of time during which events are collected and inspected or for a predetermined number of events. Each service that is processing the events will then emit a message of what they believe the schema for the collection is onto the message bus. An instance of the schema manager 124 will then be selected as the leader by the schema component 120 for the election and will listen to the various proposed schemas from each service. The instance of the schema manager 124 will create an overall schema from the received proposed schemas. The schema component 120 will then compare the overall schema with the elected or proposed schemas to determine if there are any conflicts. If the overall schema does not conflict, the instance of the schema manager 124 will emit a message that includes the selected schema and the various services will adopt this as the new schema to use for storing the events.

The schema manager 124 also monitors for potential schema conflicts. Building on the example above, when analyzing the proposed schemas from the various services, the instance of the schema manager 124 may determine that one or more of the proposed schemas conflicts with the other proposed schemas and that the schemas cannot be converged to remove the conflict. When this occurs, the instance of the schema manager 124 can emit a conflict message that informs the services that the collected events cannot be written to final storage until the conflict has been resolved. The resolution of such a conflict may require user intervention, such as correcting the structure of the conflicting events or other measures.

The goal of the schema component 120 is to infer or create a schema for a collection of events so that the events can be stored by the storage component 130. For those collections that do not include a predefined schema, the schema component 120 infers the schema from the incoming data and can update or revise the schema as necessary. By providing a schema to the incoming event data, the schema component 120 provides a structure in which the storage component 130 can store the data in a manner that is searchable and accessible by the event insight platform 100.

The storage component 130 receives the ingested events and stores them in both cold storage 132 and hot storage 136. As the naming implies, the event data in the cold storage 132 is less readily accessible than the event data in the hot storage 136. The hot storage 136 contains some but not necessarily all of the collected event data and the cold storage 132 contains all of the collected event data. Both the cold storage 132 and hot storage 136 are accessible by the search component 140. However, the searching of the hot storage 136 will return results faster than that of the cold storage 132. In an example implementation, a predefined amount of event data, such as a predefined period of collected event data, will be stored in the hot storage 136 so that it is more readily accessible for the search component 140.

The storage component 130 stores events in a predetermined cold storage 132, such as S3 storage, using a schema 134 that was inferred by the schema component 120. In some examples, the event data is stored in a parquet format and Hive tables are generated for the event data based on the schema. The events stored in the cold storage 132 can be used by the search component 140 for the search function 142 and for replay (e.g., replay function 144).

The event data, or a portion thereof, is also stored in the hot storage 136. The hot storage 136 is a search cache that the search component 140 can use to quickly return results for the search function 142.

During a replay operation (e.g., replay function 144), event data can be retrieved from either the cold storage 132 or a combination of the hot storage 136 and cold storage 132. A user can configure the replay to include only past events, e.g., events that are stored in cold storage 132. Alternatively, the user can configure the replay to include past events and any newly received events that meet the same user-specified parameters. In this example, the past events will be retrieved from cold storage 132 while any newly received events will be replayed from the hot storage 136. In some implementations, one-time replays and continuous replays can be implemented. One-time replies include replays in which the source of the data will only come from cold storage. Continuous replays include replays that continue running even after the last bit of data is replayed, after which any new data will be replayed automatically from the hot storage 136.

In addition to storing the ingested events, the storage component 130 can also include a metrics component 138 that tracks various metrics of the stored events. These metrics can be populated in a user dashboard so that they can ascertain various details of their messages that are being processed by the event insight platform 100. The metrics can include the number of events that have been processed, the throughput of the events, and other details regarding the events and their processing and storage by the event insight platform 100.

The search component 140 of the event insight platform 100 includes the search function 142 and the replay function 144. The search component 140 can interact with the cold storage 132 and hot storage 136 storage to retrieve events. Since the events are processed and stored in near real-time by the event insight platform 100, the search component 140 is able to provide functionality that is similarly near real-time.

The search function 142 allows the user to provide search inputs that will be used to search the events. In an example, the search function 142 uses Lucene-like syntax and full-text searching to allow the user to provide their search inputs. The search function 142 will use the user provided search inputs to search events in the hot storage 136 and return the results to the user. However, these returned search results may not be inclusive of all the results, as there may be event data that is not in the hot storage 136. To get the complete search results, the user can elect to extend the search to the cold storage 132. By performing the search in this manner, the search function 142 can quickly return relevant results to the user, thus allowing the user to verify that their search inputs are returning the desired or expected results. The user can then extend this search to all of their stored events, which can assist with increasing the efficiency of the user's searching.

The replay function 144 allows the user to take a subset or all of their stored events and replay them through one of their event buses or systems. This can be useful for testing functionality of the system, such as after updates or repairs. The user can select a subset of their event data, such as by use of a search query, and direct that this event data be sent to a user specified destination, e.g., the user's system(s). The user can then observe how their system handles the replayed events, such as to test that the event handling functionality of the system is functioning properly.

In another example, the replay function 144 can be used to reprocess events that might not have been initially processed by one or more of the user's systems. Since the event insight platform 100 captures and stores events from the user's systems, it can serve as a log of the various events that occurred within. If something causes one or more of the user's systems or services to not process events due, such as due to downtime or other errors, the user can use the replay function to define the affected events and send those events back through, e.g., the client system 150, so that these messages are processed properly by the user's systems and/or services. For example, the client system 150 may identify two missing events and operate to replay them back into their messaging systems for reprocessing. Such a process is advantages as it enables identification of small data sets from a substantially larger data set in an efficient manner.

The other features and functions of the event insight platform 100 allow the replay function 144 to be simply and easily integrated for use by a user with their events. Typically, such functionality would require custom development work and would likely be platform dependent (i.e., not universal). However, because the event insight platform 100 can interact with a number of various messaging and event services and stores the events in a standard format, users can utilize this replay function 144 that would be otherwise limited.

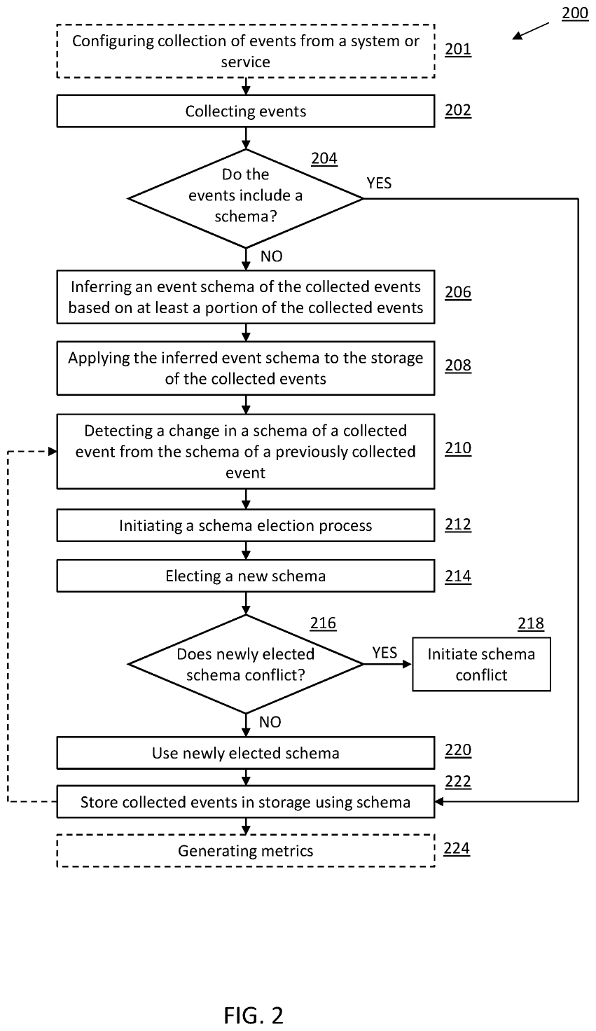

FIG. 2 is an example method 200 of ingesting, processing and storing events, such as by the event insight platform 100 of FIG. 1. Events from a user system are provided to, and processed and stored by event insight platform where users can then search their collected events. Additionally, the event insight platform is able to interface with a variety of different types of message systems and message formats, allowing the platform to be broadly used without requiring undue effort and knowledge on the part of the user.

At 201, optionally, collection of events or event data from a system, such as a user's system(s), can be configured. Configuring the collection of the events or event data can include configuring a collector or other mechanism to provide events generated within a user's systems to a remote event insight platform, such as event insight platform 100 of FIG. 1. An event collector can be a specific collector configured for a specific event messaging platform, a general collector such as an API, or a relay that the user can integrate with their system to send the generated events to the event insight platform.

As previously mentioned, a collector that collects the event data from a user's systems can also include or interact with a decoder to allow encoded event data to be read. Some event or messaging platforms may encode event data and that may hinder the ability to provide insight into that event data in a near real-time manner. A decoding component, such as a decoder that decodes the event data, assists with enabling the event insight platform to gain insight into the contents of the event data. The ability to decode event data in near real-time allows for the encoded event data contents to be included in the various insight features and functions offered by the event insight platform 100.

At 202, event data is collected from a system and provided to a remote event insight platform. The event data can be relayed over a network connection from the user's systems, by a collector, to the event insight platform systems.

At 204, it can be determined if the event data includes a schema. By its nature, some event data will include information regarding the schema of the event data structure or such schema may be provided, such as by the user. However, some event data may not include such schema information. Typically, this would require that an individual determine and define the schema of the event data structure and provide that. In the example of method 200, if the schema is not otherwise determinable from or received with the event data, the schema can be inferred.

If the event data does not include schema information and a schema is to be inferred, the method can proceed to 206. At 206, a schema for the event data can be inferred based on at least a portion of the collected event data. An example process of inferring such a schema is described above, and includes using a parser to determine the event data structure. The data structure is converted into a parquet schema using predefined parquet equivalencies.

At 208, the inferred schema is applied to the storage of the event data. The inferred schema can be a parquet schema that is used to store the data in cold storage. The parquet schema provides a structured storage that can assist with enabling the various functions and features of the event insight platform. In addition to storing the event data in a cold storage location using the inferred schema, the event data is also stored in a hot storage location that can be more readily accessible by the event insight platform. In an example implementation, all of the collected events can be stored in cold storage and at least a portion of the collected events can be stored in hot storage.

As more event data is collected, a change in the schema of the collected events may be detected at 210. In an example implementation, a service of the event insight platform may be processing received event data using the initial inferred schema and may receive subsequent event data that does not conform with this schema. This non-conformity of the schemas of the previously collected and subsequently collected event data can cause a conflict that prevents the proper storage of the complete event data.

To reconcile the change in the schema of the collected event, a schema election process can be initiated at 212 to determine a new schema that can be used to properly store the collected events. The process of using an initially determined schema and then electing a new schema in response to detecting a change in the schema of the collected events can be a looped process. In this manner, the schema associated with the collected events can be revised and updated based on the collected events.

At 214, a new schema is elected. The election of the new schema is discussed above. As noted above, the election process includes receiving proposed schemas from the various services of the event insight platform and a schema manager that elects the new schema to be used.

At 216, a determination is made as to whether the newly elected schema conflicts with the collected events. In some cases, the schema of one or more of the collected events may conflict with the schema of the other collected events in a non-reconcilable way. If this occurs, a schema conflict is initiated at 218. The schema conflict initiation may cause an indication to be provided to a user that a conflict exists and requires user intervention to correct or remedy the conflict. If the determination at 216 indicates that the newly elected schema does not conflict with the schemas of the collected events, the newly elected schema is used at 220.

At 222, the collected events are stored using the schema. The schema used to store the collected events is a parquet schema and can be the newly elected schema of 220 or can be a schema that was provided with the collected events, such as indicated by the determination at 204. The collected events are stored in cold storage using a parquet schema that may be inferred, determined or provided, and at least a portion is stored in hot storage.

At 224, metrics regarding the ingestion, processing and/or storage of the collected events can be generated. The metrics can include information such as the number of events processed, the processing rate and/or other information regarding the event insight platform. These metrics can be provided to a user so that they may gain insight into the collection of the event data.

As described above, once the event data is collected and stored, which occurs in near real-time, the user can use the event insight platform to search the events and gain insight into the collected events. Users can employ various analysis tools to analyze their collected events. Further, the event insight platform also includes replay capability, which allows users to specify a set of the collected events and to have those events “replayed” through one or more of the user's systems. The replaying of the events includes retrieving the set of events from the cold storage and then transmitting those events to the user specified destination, such as a system or service.

As discussed above, one of the features of some implementations of the event insight platform can include its ability to infer a data schema from collected events. Typically, the schema of the collected events needs to be provided prior to the event collection, so that the events could be properly stored. With the schema inference ability, the event insight platform 100 is able to analyze the incoming collected events, determine a schema based on the contents of the collected events, and store the events using the inferred schema.

As described herein, a parser is used to parse the events as they are collected. The parser can be a combination of a syntax tree parser and a lexical parser. These abilities allow the parser to ascertain the structure of the event. Predefined parquet equivalencies are used to convert the structure of the event into a parquet equivalent. This parquet equivalent is the inferred schema that is adopted for processing and storing the collected events.

The schema inference process can be iterative, allowing the schema to be updated and revised when necessary. In particular, the schema inference process may repeatedly perform the steps of 210-222 for each event or a collection of events that are received from the client system 150 over a particular time frame, e.g., on an event or collection of events having a scheme that varies from or is incompatible with a current schema. In some instances, incoming collected events may have a different schema than a previously inferred schema that is being currently used. When such issues arise, a schema election can occur to adopt a new schema that can be used to store the collected events. In particular, as data regarding an incompatible schema is collected, a new election may be determined.

A schema manager service is used to manage the schema election process. When a service of the event insight platform 100 receives a collected event that does not conform to the schema being currently used, the service will emit a message indicating that a schema election needs to occur. The schema election message is received by the other services and causes the services to begin the initial phase of the schema election process.

During the initial phase, event storage is paused and events are continued to be collected. The services analyze the collected events and each service elects a schema that fits with the collected events that each service has received. The schema manager service receives the elected schemas from the various services and develops a proposed schema based thereon.

The proposed schema determined by the schema manager is then checked for potential conflicts with the elected schemas from the services. For example, there is a determination made whether the proposed schema reconciles with the elected schemas provided by the services. If no conflicts are present, the schema manager provides the proposed schema as the newly elected schema and the services adopt this schema. If there is a conflict, e.g., the proposed schema cannot be reconciled with one or more elected schemas from the services, a schema conflict process is initiated. The schema conflict process can include alerting a user to the conflict, pausing the storage of events or continuing to store the events with a notation that the correctness of the storage is not ensured.

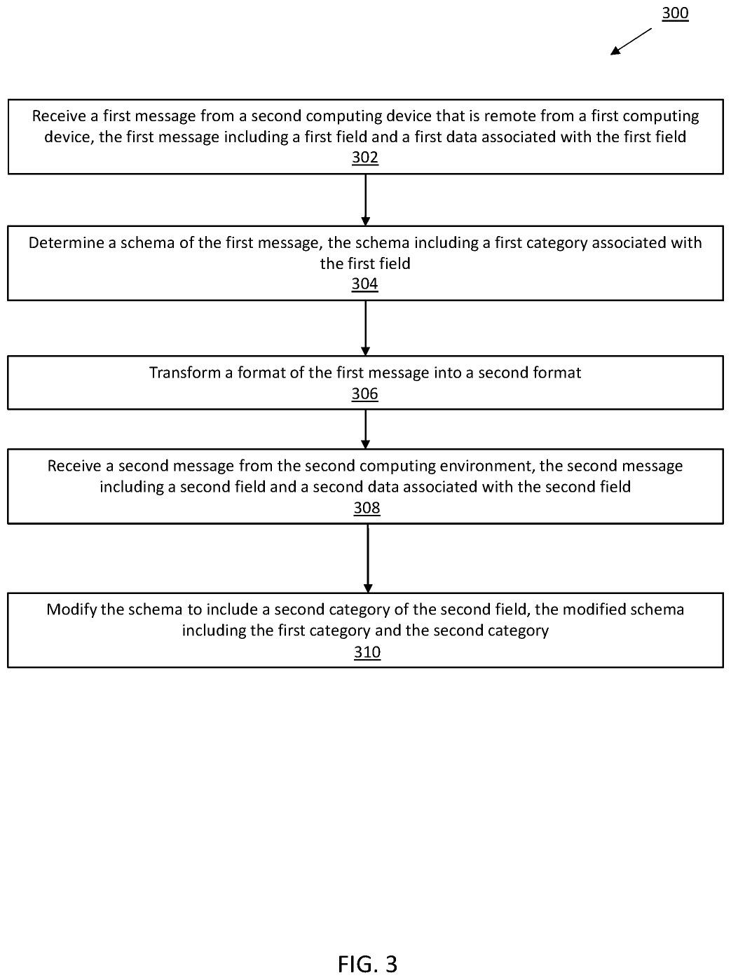

FIG. 3 illustrates an example flow chart 300 listing the steps for implementing an example schema modification and determination techniques of the present disclosure, according to one or more implementations described and illustrated herein.

At 302, a first message may be received from a second computing environment 103 by a first computing environment 101 that is separate from the second computing environment 103. The first message may include a first field and a first data associated with the first field. In some implementations, the first computing environment 101 can include the event insight platform 100 described above with reference to FIG. 1. In some implementations, the second computing environment 103 can include the client system 150 described above with reference to FIG. 1. In implementations, the first message (e.g., an event) may include a first field and a first data associated with the first field. For example, the first field associated with the data may define a characteristic or category that is specific to the first data, e.g., “First Name”, and the first data may be a first name of an individual, e.g., “Michael.”

In implementations, the first message may be encoded. For example, prior to transmission of the first message, the client system 150 may encode the first data using one or more encoding techniques to mask the subject matter of the data, e.g., for maintaining data confidentiality, privacy, and so forth.

At 304, a schema of the first message, the schema including a first category associated with a first field may be determined. In some implementations, the schema of the first message may be determined by the schema component 120 of the event insight platform 100. In implementations, the first field may be a first name of an individual and a first category may be a general descriptor associated with the field of “First Name.” In implementations, based on the data included in the first message that is received in 302, the schema component 120 may analyze data associated with the first message and generate a schema that generally describes or is associated with the text string such as “Michael” included in the data.

In implementations, the generated schema may include a category such as identification information, party name, first name, and so forth. In implementations, the category (e.g., first category) of the generated schema may be a broad descriptor of the subject matter of the data (e.g., the term “Michael”) such that data included in messages received in the future that are, for example, even somewhat related to the term “Michael,” may be classified in this category. For example, the generated schema may include a first category of “identification information,” which may include a first name comprising a single text string, a first name that includes a hyphenated first name, e.g., “Jean-Claude,” “Jean-Michel,” and so forth. In some implementations, if a particular message that is received by the event insight platform 100 (e.g., the first message, is encoded) prior to determining the schema of the first message, the schema component 120 may decode the encoded first message in order to access the first data in the message. The schema component 120 may then generate a schema associated with the first data.

At 306, the schema component 120 may transform a format of the first message into a second format. In implementations, the first data may be in a first format (e.g., text format) and may be converted into a second format, e.g., JSON, GeoJSON, and so forth. In embodiments, prior to transforming the format of the first message into the second format, the first message may be parsed. In implementations, parsing of the first data may include partitioning portions of the first data for various purposes, e.g., identifying patterns in the data, analyzing the data to determine differences between characters in the data (e.g., differences between numbers, symbols, etc.), identifying relationships between the characters, and so forth. Further, the parsed first message may be stored using a first syntax that is based on the schema of the first message. For example, the first syntax may be one or more symbols, text, numbers, or combination thereof that is representative of the schema of the first message, e.g., schema that is based on the first category of, e.g., “First Name.” Further, it is noted that any subsequent changes in the schema will result in an automatic updating of the first syntax such that the first syntax will match the schema. For example, if the modified schema includes “First Name” and “Last Name” (first category and second category), the first syntax that initially only included a symbol, text, number, or combination thereof that represented the category of “First Name” (e.g., first category) may now include another symbol that is representative of the “Last Name” (e.g., the second category). Any additional changes to the schema will result in corresponding changes to the first syntax. In embodiments, the modified first syntax may be stored or referenced as a second syntax. Similarly, a further modification of the syntax may be stored or referenced as a third syntax representing, for example, a third category.

In implementations, the first message and the second message are received from an agent operating on a first device of the second computing environment such that the agent monitors messages between components of the second computing environment and transmits copies of messages to the first computing environment. For example, the agent may be a combination of hardware and software included as part of the client system 150 and may operate such that one or more messages generated by the message content producers component 152 may be routed via the message bus component 154 to the event collection component 156.

At 308, the event insight platform may receive a second message from the second computing environment. The second message may include a second field and a second data associated with the second field. For example, the second message may include second data in the form of the text string “Smith” and the second field may be, e.g., “Last Name.” In implementations, the second data may also be associated with a text string in the form of an address associated with an individual, and so forth.

At 310, the schema component may modify the schema to further include a second category of the second field, the modified schema including the first category and the second category. In implementations, upon receiving the second message including the second data such as the text string “Smith” and the second field of “Last Name,” the schema component 120 may analyze both the second data and the second field and generate a category that serves as a broad descriptor associated with the text string “Smith.” Further, a part of modifying the schema includes the step of determining whether the first field varies from the second field. If the schema component determines that the first field varies from the second field, the schema component may operate to modify the schema as described above, e.g., modify the schema to include the first category and the second category.

For example, the second category may be defined as “Last Name,” “Party Identification Information,” and so forth. Further, in implementations, the modified schema may include multiple categories or descriptors in the form of such as “First Name” and “Last Name.” When messages are received in the future, data included in these messages like text strings “John Smith”, “Jane Doe”, and so forth, may be classified such that the text “John” and “Jane” may automatically be classified under and stored in association with the first category of “First Name” (or another comparable or related descriptor) and the text “Smith” and “Doe” may be classified under and stored in association with the second category of “Last Name.” Further, the respective first names may be stored in associated with the respective last names. These steps may be performed by the schema component.

The generation and modification of the schema may involve a multistep schema election process. In implementations, the first message may be received by a first node associated with a second device of the first computing environment 101 and the second message may be received by a second node associated with the second computing device of the first computing environment 101. The second device may be one or more computing devices operating independently or in conjunction, and the first and second nodes may be software operating on hardware of the first computing environment.

As part of the schema election process, the first node may provide an input to a schema decision node. The input can be associated with the at least the first field included in the first message. In such an example, the second node may further provide an additional input to the schema decision node. The additional input can be associated with the at least the second field included in the second message. Thereafter, the modified schema may be generated based on input from the first node and the additional input from the second node such that the modified schema includes the first category associated with the first field and the second category associated with the second field. In implementations, the input and the additional input may include routing of the first and second fields, e.g., “First Name” and “Last Name”, and the potential categories or descriptors associated with the first and second fields to the schema decision node. Based on these inputs, the schema decision node may generate and/or modify the current schema to include the first category and the second category.

In embodiments, a third message including a third field and third data that is independent of the third field may also be received. In implementations, the third message may include an address field and the third data being independent of the third field may be such that the third data fails to comply with and fails to be associated with the third field. For example, the third field may be a mailing address field and the third data may include a symbol, e.g., “#”, “$”, “@”, and so forth, which does not comply with the mailing address field. In other words, the third data may be erroneous and be classified as data that initiates a backwards breaking chain.

In such an instance, the third data may be modified such that the modified third data is associated with the third field. In implementations, upon the determining of the existence of a backwards breaking chain of data, the event insight platform 100 may, operating independently or in conjunction with one or more external devices, apply a function to correct one or more errors in the third data. For example, if the third data has address information, e.g., “125 Chest$nut Street,” the applied function may identify the erroneous and noncompliant symbol of “$” and delete it. In this way, the modified third data may be in compliance with the third field, e.g., the address field.

In implementations, the event insight platform 100 may also facilitate the resource efficient and user friendly retrieval, transmission, and replay of content stored in the one or more databases. In implementations, a request for replaying content that is stored in storage may be received. For example, a query may be transmitted by the client system 150 to the event insight platform 100 such as, e.g., query for replaying an audio-visual recording (e.g., a teleconference) between multiple parties on Jun. 12, 2020.

Content that is stored in the storage may be retrieved in response to such a request or query. For example, the search component 140 may analyze the text of the request using a search function 142, identify the date of the request, the format of the content requested in the query, the party associated with the request, and so forth, in a resource efficient manner. Thereafter, the storage component 130 may identify the precise location in which the content is stored. In this way, the pertinent content may be retrieved.

In implementations, the content that is retrieved may be transmitted to the first device of the second computing environment 103. For example, the replay function 144 operating in conjunction with one or more parts of the event insight platform 100 may transmit the retrieved content to the first device of the second computing environment 103, e.g., nearly in real time. In some implementations, the replay function 144 may facilitate replay of the recording such that a requestor (included in the second computing environment 103) may be able to view the recording being output in the first computing environment 101.

Although a few variations have been described in detail above, other modifications or additions are possible. For example, although parquet has been described as a format, other format or data organizations are also possible. Some implementations of the current subject matter can provide many technical advantages.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

Further non-limiting aspects or implementations are set forth in the following numbered clauses:

Clause 1: A method comprising: receiving, by a first computing environment, a first message from a second computing environment remote from the first computing environment, the first message including a first field and a first data associated with the first field; determining, based on the first field, a schema of the first message, the schema including a first category associated with the first field; transforming a format of the first message into a second format; receiving, by the first computing environment, a second message from the second computing environment, the second message including a second field and a second data associated with the second field; and modifying the schema to further include a second category of the second field, the modified schema including the first category and the second category.

Clause 2: The method of clause 1, further comprising: parsing, prior to the transforming of the format of the first message into the second format, the first message; and wherein the first message and the second message are received from an agent operating on a first device of the second computing environment, the agent monitoring messages between components of the second computing environment and transmitting copies of messages to the first computing environment.

Clause 3: The method of clause 1 or clause 2, further comprising: further comprising: receiving, by the first computing environment, a third message including a third field and a third data that is independent of the third field; and modifying, using at least a function, the third data such that the modified third data is associated with the third field.

Clause 4: The method of clause 1, further comprising: receiving, by a first node associated with a second device of the first computing environment, the first message; and receiving, by a second node associated with the second device of the first computing environment, the second message.

Clause 5: The method of any of clause 4, wherein the modifying of the schema comprising: providing, by the first node and to a schema decision node, an input associated with the at least the first field included in the first message; providing, by the second node and the schema decision node, an additional input associated with at least the second field included in the second message; and generating by the schema decision node, based on the input from the first node and the additional input from the second node, the modified schema that includes the first category associated with the first field and the second category associated with the second field.

Clause 6: The method of clause 5, further comprising storing the second message in storage using a second syntax that is based on the modified schema, the second syntax based on the first category and the second category.

Clause 7: The method of clause 6, further comprising: further modifying the modified schema to include a third category that is associated with a third field, wherein the further modifying of the modified schema causes the further modified schema to include the first category, the second category, and the third category; parsing a third message; and storing the third message in the storage using a third syntax, the third syntax based on the first category, the second category, and the third category.

Clause 8: The method of any of clauses 1-7, wherein the first message is encoding; and decoding the first message that is encoded prior to determining the schema of the first message.

Clause 9: The method of any of clauses 1-8, further comprising: parsing the first message upon determining the schema of the first message; storing the first message in storage using a first syntax that is based on the schema of the first message; and updating the first syntax based on the modified schema including the first category and the second category.

Clause 10: The method of any of clauses 1-9, further comprising: receiving, by the first computing environment that is remote from the second computing environment, a request for replaying content that is stored in storage; retrieving the content that is stored in the storage responsive to the request; and transmitting the content that is retrieved to a first device of the second computing environment.

Clause 11: The method of clause 10, wherein: the determining includes the determining of the schema of the first message by a schema component included as part of the first computing environment; the retrieving includes the retrieving of the content from a storage component included as part of the first computing environment, wherein the storage component includes a cold storage component and a hot storage component; and the receiving of the request includes the receiving of the request for replaying the content by a search component.

Clause 12: The method of claim 1, further comprising: determining whether the first field varies from the second field; and modifying the schema such that the modified schema includes the first category and the second responsive to determining that the first field varies from the second field.

Clause 13: A system comprising: at least one data processor; and memory storing instructions which, when executed, cause the at least one data processor to perform operations comprising: receiving, by a first computing environment, a first message from a second computing environment remote from the first computing environment, the first message including a first field and a first data associated with the first field; determining, based on the first field, a schema of the first message, the schema including a first category associated with the first field; transforming a format of the first message into a second format; receiving, by the first computing environment, a second message from the second computing environment, the second message including a second field and a second data associated with the second field; and modifying the schema to further include a second category of the second field, the modified schema including the first category and the second category.

Clause 14: The system of clause 13, wherein the operations further comprise: parsing, prior to the transforming of the format of the first message into the second format, the first message; and wherein the first message and the second message are received from an agent operating on a first device of the second computing environment, the agent monitoring messages between components of the second computing environment and transmitting copies of messages to the first computing environment.

Clause 15: The system of clause 14, wherein the operations further comprise: receiving, by the first computing environment, a third message including a third field and a third data that is independent of the third field; and modifying, using at least a function, the third data such that the modified third data is associated with the third field.

Clause 16: The system of any of clauses 13-15, wherein the operations further comprise: receiving, by a first node associated with a second device of the first computing environment, the first message; and receiving, by a second node associated with the second device of the first computing environment, the second message.

Clause 17: At least one non-transitory computer readable media storing instructions that, when executed by at least one processor, cause the at least one processor to perform operations comprising: receiving, by a first computing environment, a first message from a second computing environment remote from the first computing environment, the first message including a first field and a first data associated with the first field; determining, based on the first field, a schema of the first message, the schema including a first category associated with the first field; transforming a format of the first message into a second format; receiving, by the first computing environment, a second message from the second computing environment, the second message including a second field and a second data associated with the second field; and modifying the schema to further include a second category of the second field, the modified schema including the first category and the second category.

Clause 18: The at least one non-transitory computer readable media of claim 17, wherein the operations further comprise: parsing, prior to the transforming of the format of the first message into the second format, the first message; and wherein the first message and the second message are received from an agent operating on a first device of the second computing environment, the agent monitoring messages between components of the second computing environment and transmitting copies of messages to the first computing environment.

Clause 19: The at least one non-transitory computer readable media of claim 18, wherein the operations further comprise: receiving, by the first computing environment, a third message including a third field and a third data that is independent of the third field; and modifying, using at least a function, the third data such that the modified third data is associated with the third field.

Clause 20: The at least one non-transitory computer readable media of claim 17, wherein the operations further comprise: receiving, by a first node associated with a second device of the first computing environment, the first message; and receiving, by a second node associated with the second device of the first computing environment, the second message.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, by a first computing environment, a first message from a second computing environment remote from the first computing environment, the first message including a first field and a first data associated with the first field;
determining, based on the first field, a schema of the first message, the schema including a first category associated with the first field;
transforming a format of the first message into a second format;
receiving, by the first computing environment, a second message from the second computing environment, the second message including a second field and a second data associated with the second field; and
modifying the schema to further include a second category of the second field, the modified schema including the first category and the second category.

2. The method of claim 1, further comprising:
parsing, prior to the transforming of the format of the first message into the second format, the first message; and
wherein the first message and the second message are received from an agent operating on a first device of the second computing environment, the agent monitoring messages between components of the second computing environment and transmitting copies of messages to the first computing environment.

3. The method of claim 2, further comprising:
receiving, by the first computing environment, a third message including a third field and a third data that is independent of the third field; and
modifying, using at least a function, the third data such that the modified third data is associated with the third field.

4. The method of claim 1, further comprising:
receiving, by a first node associated with a second device of the first computing environment, the first message; and
receiving, by a second node associated with the second device of the first computing environment, the second message.

5. The method of claim 4, wherein the modifying of the schema comprising:
providing, by the first node and to a schema decision node, an input associated with the at least the first field included in the first message;
providing, by the second node and the schema decision node, an additional input associated with at least the second field included in the second message; and
generating by the schema decision node, based on the input from the first node and the additional input from the second node, the modified schema that includes the first category associated with the first field and the second category associated with the second field.

6. The method of claim 5, further comprising storing the second message in storage using a second syntax that is based on the modified schema, the second syntax based on the first category and the second category.

7. The method of claim 6, further comprising:
further modifying the modified schema to include a third category that is associated with a third field, wherein the further modifying of the modified schema causes the further modified schema to include the first category, the second category, and the third category;
parsing a third message; and
storing the third message in the storage using a third syntax, the third syntax based on the first category, the second category, and the third category.

8. The method of claim 1, wherein
the first message is encoding; and
decoding the first message that is encoded prior to determining the schema of the first message.

9. The method of claim 1, further comprising:
parsing the first message upon determining the schema of the first message;
storing the first message in storage using a first syntax that is based on the schema of the first message; and
updating the first syntax based on the modified schema including the first category and the second category.

10. The method of claim 1, further comprising:
receiving, by the first computing environment that is remote from the second computing environment, a request for replaying content that is stored in storage;
retrieving the content that is stored in the storage responsive to the request; and
transmitting the content that is retrieved to a first device of the second computing environment.

11. The method of claim 10, wherein:
the determining includes the determining of the schema of the first message by a schema component included as part of the first computing environment;
the retrieving includes the retrieving of the content from a storage component included as part of the first computing environment, wherein the storage component includes a cold storage component and a hot storage component; and
the receiving of the request includes the receiving of the request for replaying the content by a search component.

12. The method of claim 1, further comprising:
determining whether the first field varies from the second field; and
modifying the schema such that the modified schema includes the first category and the second responsive to determining that the first field varies from the second field.

13. A system comprising:
at least one data processor; and
memory storing instructions which, when executed, cause the at least one data processor to perform operations comprising:
receiving, by a first computing environment, a first message from a second computing environment remote from the first computing environment, the first message including a first field and a first data associated with the first field;
determining, based on the first field, a schema of the first message, the schema including a first category associated with the first field;
transforming a format of the first message into a second format;
receiving, by the first computing environment, a second message from the second computing environment, the second message including a second field and a second data associated with the second field; and
modifying the schema to further include a second category of the second field, the modified schema including the first category and the second category.

14. The system of claim 13, wherein the operations further comprise:
parsing, prior to the transforming of the format of the first message into the second format, the first message; and
wherein the first message and the second message are received from an agent operating on a first device of the second computing environment, the agent monitoring messages between components of the second computing environment and transmitting copies of messages to the first computing environment.

15. The system of claim 14, wherein the operations further comprise:
receiving, by the first computing environment, a third message including a third field and a third data that is independent of the third field; and
modifying, using at least a function, the third data such that the modified third data is associated with the third field.

16. The system of claim 13, wherein the operations further comprise:
receiving, by a first node associated with a second device of the first computing environment, the first message; and
receiving, by a second node associated with the second device of the first computing environment, the second message.

17. At least one non-transitory computer readable media storing instructions that, when executed by at least one processor, cause the at least one processor to perform operations comprising:
receiving, by a first computing environment, a first message from a second computing environment remote from the first computing environment, the first message including a first field and a first data associated with the first field;
determining, based on the first field, a schema of the first message, the schema including a first category associated with the first field;
transforming a format of the first message into a second format;
receiving, by the first computing environment, a second message from the second computing environment, the second message including a second field and a second data associated with the second field; and
modifying the schema to further include a second category of the second field, the modified schema including the first category and the second category.

18. The at least one non-transitory computer readable media of claim 17, wherein the operations further comprise:
parsing, prior to the transforming of the format of the first message into the second format, the first message; and
wherein the first message and the second message are received from an agent operating on a first device of the second computing environment, the agent monitoring messages between components of the second computing environment and transmitting copies of messages to the first computing environment.

19. The at least one non-transitory computer readable media of claim 18, wherein the operations further comprise:
receiving, by the first computing environment, a third message including a third field and a third data that is independent of the third field; and
modifying, using at least a function, the third data such that the modified third data is associated with the third field.

20. The at least one non-transitory computer readable media of claim 17, wherein the operations further comprise:
receiving, by a first node associated with a second device of the first computing environment, the first message; and
receiving, by a second node associated with the second device of the first computing environment, the second message.
